(19) United States
(12) Patent Application Publication
(10) Pub. No.: US 2011/0289443 A1
(43) Pub. Date: Nov. 24, 2011

(54) Behavioral Training and Development

(75) Inventors: Craig Heaven, Tunbridge Wells (GB); Javier Bajer, Godalming (GB)

(73) Assignee: WORKFORCEPERFORMANCE LLP, London (GB)

(21) Appl. No.: 12/783,168

(22) Filed: May 19, 2010

(51) Int. Cl. G06Q 10/00; G06F 3/048

(52) U.S. Cl. 715/772; 705/7.42

(57) ABSTRACT

Behavioral changes may be generated by providing tools that allow a user to 1) gain awareness of the alignment and misalignment between beliefs, intentions, promises or actions; 2) identify actions to take to restore alignment and create value-added change; 3) define and structure practice to build skills in the above and 4) track progress in achieving resolution of underlying issues and problems. Such tools may include visualizations of a user's progress toward a particular behavioral change goal and a user's relationship status and relationship quality with other individuals. Additionally, a tool may be provided to provoke the user into evaluating his or her own traits, thoughts and thought processes. The behavioral training may be performed at an individual level as well as for organizations or other groups of individuals. In one example, a coaching hierarchy may be defined that leverages the experiences of more experienced individuals for all less experienced trainees while maintaining manageable training assignments for each coach.

### BACKGROUND

Development of soft skills such as leadership and corresponding behavioral changes requires practice. Merely reading about or gaining insight into improving leadership or other skills is often insufficient. Accordingly, the appropriate actions and skills must be practiced, otherwise, the incorrect skills or behaviors may be reinforced. However, the practicing of these skills cannot be rushed since soft skills are generally more effectively learned through progressive practice. Further, the individual being trained must be kept motivated since without motivation, the individual is unlikely to keep up with a practice or training routine.

Additionally, many current training programs are either effective and not scalable or scalable but ineffective. Accordingly, culture and behavioral changes at an organizational level are often difficult to achieve using current tools since such changes require the effective and coordinated training of a significant number of individuals.

### SUMMARY

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the description below.

Aspects of the present disclosure relate to modifying behavior of individuals to achieve improvement in performance on both an individual level and an organization level. A behavioral change system may include multiple tools to help motivate and encourage a user to take actions directed toward achieving the behavioral change. Organizational changes and improvements, for example, may be produced by coordinating changes among individuals that aid in achieving the organizational objectives. Using a hierarchical coaching structure, one or more coaches may monitor the progress of their respective trainees to insure that progress is being made and at an appropriate pace. Scalability may further be achieved using such a hierarchical coaching structure. The coaches may customize or advise on actions and objectives for each individual based on their current level of performance.

According to another aspect, changing individual behavior may include providing visualization tools to help the individual stay motivated and entertained. The visualization tools may be configured to provide the individual with a sense of achievement and accomplishment. In one example, an image may be displayed in multiple states of growth. The image may progress from state to state based on the user's level of progress in completing goals, actions and objectives assigned or self assigned to him or her. In another example, a relationship tracking and monitoring tool may include visualizations that represent a quality and status of a relationship between a first individual and multiple other individuals. Various aspects of the visualization such as a color, a fill level of an icon or image, a distance from an icon representing the first individual to icons representing the other individuals may be used to convey different attributes of the relationship. As such, the user may gain a comprehensive understanding of a relationship rather than a piecemeal view.

According to yet another aspect, changing individual behavior may include asking the user to perform a self-analysis of his or her own thought processes including actions, promises, beliefs and intentions. While misalignments in the user's actions, promises, beliefs or intentions may be identified by others and communicated to the user, it may be more effective for affecting permanent and genuine behavioral change when a user is able to come to these realizations by himself or herself. According, a self-analysis tool that prompts the user with thought provoking questions may be provided as part of completing an action and objective or other goal. For example, a user may identify actions that should be taken to correct the misalignments.

According to still another aspect, users may publish information relating to their goals, objectives, actions and progress on a social networking page or site. For example, a user may display a progress bar achieving an objective, improving a relationship or resolving an issue on a FACEBOOK page. In one or more arrangements, users may also collaborate on various actions or objectives. For example, users may discuss approaches to completing a particular action or resolving a certain type of issue. Alternatively or additionally, users may plan joint activities to complete an action or objective. The networking and/or collaboration site may be provided by a behavior modification system by providing, for example, a chat forum or other multi-user interactive interfaces.

### BRIEF DESCRIPTION OF THE DRAWINGS

The present disclosure is illustrated by way of example and not limited in the accompanying figures in which like reference numerals indicate similar elements.

FIG. 1 illustrates an example of a suitable operating environment in which various aspects of the disclosure may be implemented.

FIG. 2 is a flowchart illustrating a method for training one or more behavioral attributes of a user according to one or more aspects described herein.

FIG. 3 illustrates an example tool for scheduling actions and goals according to one or more aspects described herein.

FIG. 4 illustrates an example cognitive analysis tool according to one or more aspects described herein.

FIG. 5 illustrates a training progress tracking interface according to one or more aspects described herein.

FIGS. 6A-6D illustrate a series of user interfaces displaying a progress tracking image in a plurality of states according to one or more aspects described herein.

FIG. 7 illustrates an example progress reporting message according to one or more aspects described herein.

FIG. 8 illustrates an interface displaying a relationship map according to one or more aspects described herein.

FIGS. 9-11 illustrate progress overview interfaces including multiple progress tracking graphs and tables according to one or more aspects described herein.

FIG. 12 illustrates an example coaching hierarchy tree according to one or more aspects described herein.

FIG. 13 illustrates an example challenge prompt according to one or more aspects described herein.

FIG. 14 is a flowchart illustrating an example method for setting an objective goal and monitoring progress thereof according to one or more aspects described herein.

### DETAILED DESCRIPTION

In the following description of various illustrative embodiments, reference is made to the accompanying drawings, which form a part hereof, and in which is shown, by way of illustration, various embodiments in which the claimed subject matter may be practiced. It is to be understood that other embodiments may be utilized and structural and functional modifications may be made without departing from the scope of the present claimed subject matter.

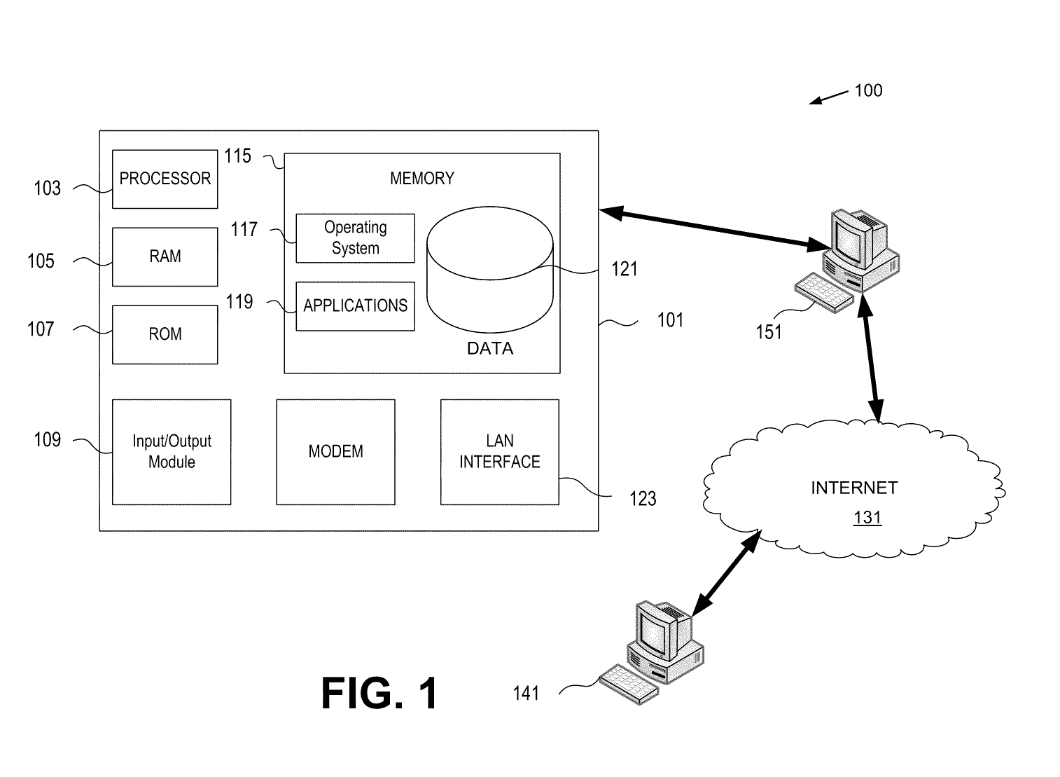

FIG. 1 illustrates a block diagram of a generic computing device 101 (e.g., a computer server) in computing environment 100 that may be used according to an illustrative embodiment of the disclosure. For example, computing device 101 may be configured to provide a behavioral training and development system that aids users in effectuating changes in their behavior and in developing soft skills such as leadership. By modifying aspects of their behavior, the system may help maximize a user's performance within an environment such as a workplace. The system may further be scaled to aid in the training of multiple users, potentially resulting in an improvement to an organization or other multi-individual entity. Effective modification of user behavior may include a variety of tools, strategies and methods. For example, various methods and systems may be used to maximize the translation of learned information to performance improvements in an environment such as a workplace. In another example, a user may be led to self-realizations regarding various user attributes and behavioral characteristics. By allowing a user to come to such self-realizations, a user's underlying beliefs and cognitive state may be more effectively modified to maximize behavioral improvements. In yet another example, relationships between users in a workplace may be developed and trained by the training and development system to enhance the performance of the overall workplace.

The computing device 101 may have a processor 103 for controlling overall operation of the computing device and its associated components, including random access memory (RAM) 105, read-only memory (ROM) 107, input/output (I/O) module 109, and memory 115. I/O 109 may include a microphone, mouse, keypad, touch screen, scanner, optical reader, and/or stylus (or other input device(s)) through which a user of computing device 101 may provide input, and may also include one or more of a speaker for providing audio output and a video display device for providing textual, audiovisual and/or graphical output. Software may be stored within memory 115 and/or other storage to provide instructions to processor 103 for enabling computing device 101 to perform various functions. For example, memory 115 may store software used by the computing device 101, such as an operating system 117, application programs 119, and an associated database 121. Alternatively, some or all of computing device 101 computer executable instructions may be embodied in hardware or firmware (not shown).

The computing device 101 may operate in a networked environment supporting connections to one or more remote computers, such as terminals 141 and 151. The terminals 141 and 151 may be personal computers or servers that include many or all of the elements described above relative to the computing device 101. The network connections depicted in FIG. 1 include a local area network (LAN) and a wide area network (WAN), but may also include other networks. When used in a LAN networking environment, the computer 101 may be connected to the LAN through a network interface or adapter 123. When used in a WAN networking environment, the computing device 101 may include a modem or other network interface for establishing communications over the WAN, such as the Internet 131. It will be appreciated that the network connections shown are illustrative and other means of establishing a communications link between the computers may be used. The existence of any of various well-known protocols such as TCP/IP, Ethernet, FTP, HTTP, HTTPS, and the like is presumed.

Computing device 101 and/or terminals 141 or 151 may also be mobile terminals (e.g., mobile phones, PDAs, notebooks, etc.) including various other components, such as a battery, speaker, and antennas (not shown).

The disclosure is operational with numerous other general purpose or special purpose computing system environments or configurations. Examples of well known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by one or more computers and/or one or more processors associated with the computers. Generally, program modules include routines, programs, objects, components, data structures, etc. that perform particular tasks or implement particular abstract data types. Aspects of the disclosure may also be practiced in distributed computing environments where tasks are performed by remote processing devices that are linked through a communications network. In a distributed computing environment, program modules may be located in both local and remote computer storage media including memory storage devices.

In one or more arrangements, devices such as computing device 101 and/or applications thereof may be used to train and modify a user's behavior. The device and application may provide a variety of tools that allow a multitude of users to engage in behavioral change. In one example, a behavioral change tool of the system may allow an organization to affect change for the entire organization through fostering change in departments and individuals therein. Producing behavioral change in individuals may be facilitated by insuring that users adhere to a specified training program. For example, a virtual or real-life coach may be assigned to users in order to insure that the users are progressing through a schedule of objectives and actions in a timely manner. The training programs may simply an overall behavioral change into one or more objectives, relationships or issues that may be improved through one or more actions. Accordingly, a user may achieve a sense of accomplishment by completing each of these actions and increase or maintain his or her motivation in completing the schedule of behavioral change tasks. The interactivity and nature of the behavioral change tools may also provide added motivation and incentive. For example, certain behavioral changes may be facilitated through various types of games that may provide both entertainment and educational value.

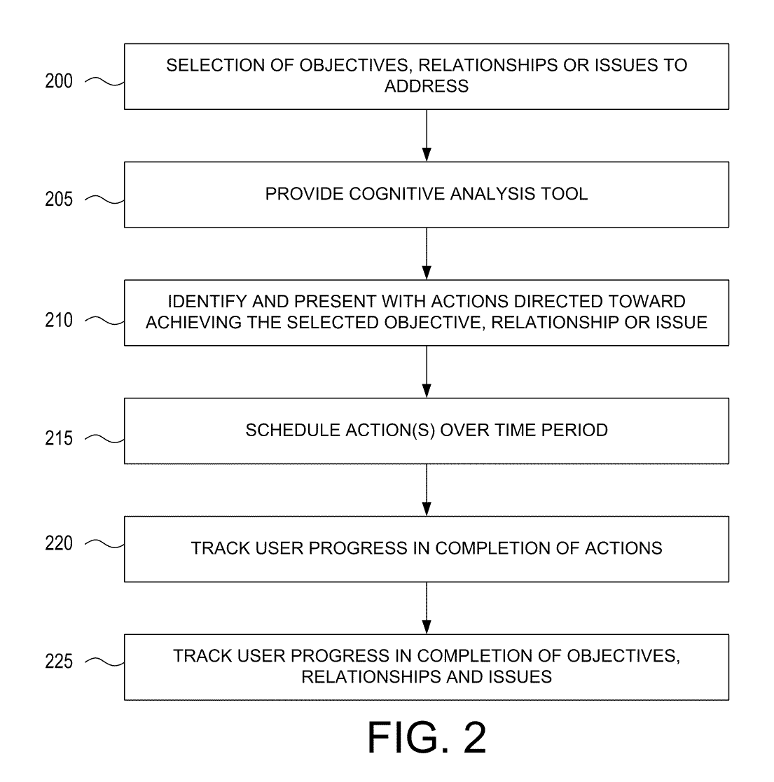

FIG. 2 illustrates a method through which a system trains and develops a user's behavior. In step 200, the user may choose from various skill development or behavioral change goals such as objectives, relationships or issues to address. Behavioral changes or skill development may include the training of non-physical attributes of the individual. Objectives may include improvement of generic behavioral traits or characteristics while issues may include specific situations, environments, conflicts that the user is seeking to resolve. A user may further choose to improve upon existing relationships or to establish new relationships. In one or more arrangements, the objectives, relationships or issues may be selected by a coach or other individual. In step 205, the system may provide a cognitive analysis tool for allowing the user to engage in self-reflection and self-analysis. The user may use the cognitive analysis tool to objectively analyze a particular action, objective, relationship or issue. Further, the training system may provide suggestions for additional objectives, relationships or issues to encourage the user to further his or her behavioral improvement beyond the initially selected objectives, relationships or issues. For example, upon determining that the user has completed 75% of his or her objectives, relationships or issues, the system may suggest additional areas of improvement to motivate the user to continue the training process and further improve his or her behavioral attributes.

In step 210, the user may be presented with actions directed toward achieving the selected objective, relationship improvement or issue resolution. The actions may be self-defined and/or selected by the user from a library of predefined actions. In one example, actions may be identified and defined by the user based on information derived through the use of the cognitive analysis tool in step 205. Actions may also be automatically selected and suggested to the user based on the selected objective, relationship or issue. Alternatively, a coach or trainer may define recommended or required actions based on the chosen objective, relationship or issue. The role of a coach or trainer may be played by another user of the organization such as a work environment to which the user being trained belongs. Actions may be associated with a particular objective, relationship or issue and may represent real world tasks (versus simulated experiences or those actions whose sole purpose is to practice the particular behavior). Accordingly, the training system or a coach may determine that an objective has been completed, a relationship has been improved and/or an issue resolved once the user has completed all actions associated therewith.

To help the user progress through the actions, the actions may be scheduled over a particular time period in step 215. The schedule may be defined the by user or, alternatively or additionally, be generated automatically and/or manually by a coach of the user being trained. In one or more examples, a schedule may be partially generated by a coach and modified by a user based on user preferences and in the event of scheduling conflicts that might be unknown to the coach. In another example, a schedule may be partially generated automatically by a system and partially manually generated by a coach or user or both. The schedule may be defined such that the actions are not required on a rapid pace since training may require progressive training over a longer period of time.

In step 220, the training system may track the user's progress in completing the various actions. Progress tracking may include displaying a number of actions completed and a number of actions pending. Additionally, the training system may further track the user's progress in completing the various objectives, relationships and issues in step 225. For example, the user's progress may be represented by an object that changes in appearance when an objective has been completed, a relationship has been improved or an issue has been resolved. An illustrative example of such a progress object is described in further detail herein. The training process may continue until all objectives, relationships and issues have been addressed or upon expiration of a time period (e.g., 100 days). Alternatively, the training process may continue indefinitely (e.g., until a user chooses to end the program). In yet another example, the end of the training program may be controlled by a coach. That is, the training program may end based on a coach's decision such as when he or she decides that the user exhibits sufficient improvement.

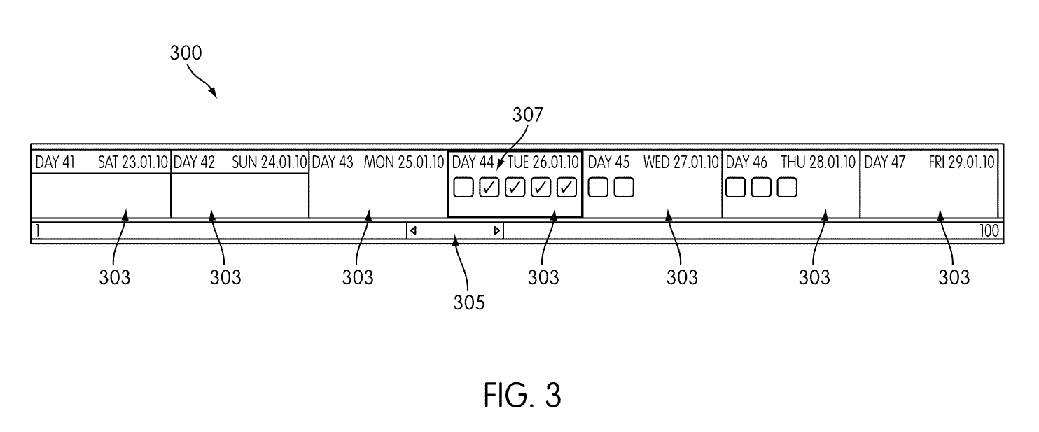

In addition to progress tracking, FIG. 3 illustrates a scheduling interface through which expected actions for completing an objective, improving a relationship or resolving an issue may be planned and indicated. Additionally, the pace of a training program may be specifically defined to maintain a user's interest and motivation. In some arrangements, a schedule may include one or more practice periods where a user is given sample or practice actions and tasks to complete.

Interface 300 includes multiple sections 303 that each correspond to a particular day. Interface 300 represents a weekly view, but may be modified to display a monthly, daily, bi-weekly, bi-monthly or yearly view. Alternatively, the user may customize the time period (e.g., view 10 days at a time). The user may also modify the time period displayed in interface 300 by using a scroll bar 305. Using scheduling interface 300, a user is able to more easily identify upcoming actions and appropriately plan or schedule his or her day, week, month, etc. Actions scheduled for a day may be identified by icons such as boxes 307. Multiple actions scheduled for a day may thus be displayed as multiple boxes. As the user completes each action, the corresponding box (or a box if all the boxes are the same and the order is not relevant) may be checked or otherwise have its appearance modified. The checking or modification in appearance of a box may be used to provide a user with a sense of accomplishment and success. In one or more arrangements, if the user places a cursor over one of the boxes, details of the corresponding action may be displayed in a pop-up window or other interface. Similarly, if a user interacts with a particular day or time period, details about the detail and actions scheduled therefore may be provided to the user.

Affecting behavioral change to achieve an objective, improve a relationship or resolve an issue may require an understanding of the underlying issues that give rise to problems or issues. In many cases, the mere communication of these underlying issues from one user to another might not be sufficient for a user to achieve true comprehension of the problems or issues. Without true comprehension, a user's change may be temporary or lack sincerity. Accordingly, a training system may instead require that a user analyze a situation (e.g., an objective, relationship or issue) to identify for himself or herself the underlying beliefs that are responsible for giving rise to the various situations. This may help lead the user to modifying these beliefs to affect permanent and genuine change in behavior.

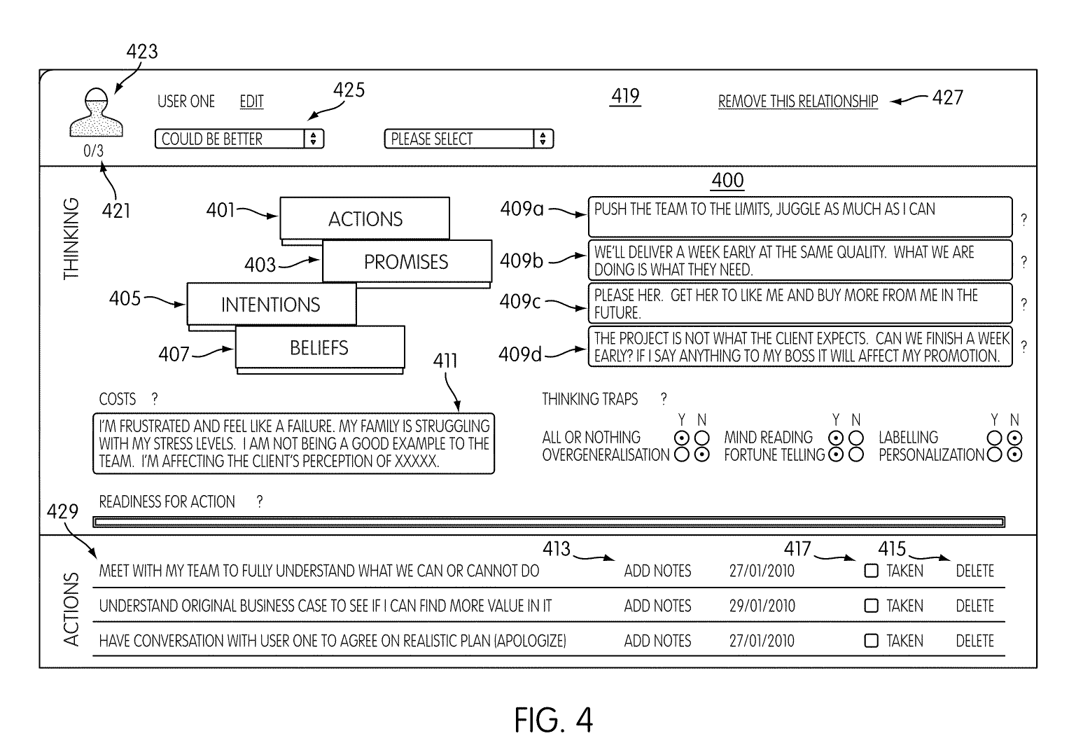

FIG. 4 illustrates an example training tool that is designed to prompt a user to reflect upon his beliefs and intentions for a particular situation. By asking the user to perform a self analysis, the user is more likely to understand, believe and realize potential issues than if another user merely communicated the issues to the user. Training tool 400 includes a number of thought topics including actions 401, promises 403, intentions 405 and beliefs 407. Users may be instructed to enter corresponding descriptions and thoughts into entry fields 409 to reflect upon the topics as they relate to the objective to be completed, relationship to be improved or issue to be resolved. For example, the illustrated example includes the goal of improving a relationship with a client or potential client named Suzanne. Accordingly, the user may enter in the actions field 409a that they would like to push their team to the limits and juggle as much as they can in order to build this relationship with Suzanne.

The user may further define promises that he or she has made, could make or is thinking of making in order to improve the relationship. For example, the user may indicate he or she would like to promise delivery of a product a week early and do what needs to be done to impress the client and thus improve the client's opinion of the user. These user's intentions may be explained and detailed in form 409c. The user may further evaluate his or her beliefs as they relate to the particular relationship or objective and including any assumptions that he or she has made. For example, the user may admit that he or she believes that the project is not what the client is expecting and that he or she has doubts as to whether the project may be completed early. Additionally, the user may have concerns about whether voicing his beliefs and concerns will affect a promotion. By fully realizing and evaluating these beliefs, a user may determine whether his or her beliefs are substantiated and rational, and in alignment with his or her intentions, promises and actions. For example, the user's concerns may earn praise from his or her boss rather than negatively affecting a potential promotion. As such, furthering and adhering to such beliefs might actually be detrimental to the user.

Training tool 400 may further include costs field 411 that may be configured to prompt the user to discuss the actual and/or potential costs of his or her current situation. Again, by understanding the costs of the user's current behavior, the user may more fully appreciate the need to change. The user may further view the costs or anticipated costs along with the actions, promises, intentions and beliefs and determine whether the costs outweigh any potential benefits that may be achieved. The tool 400 may also offer the user an opportunity to evaluate whether he or she has fallen into one or more thinking traps (e.g., cognitive distortions) or thought processes that might be adversely affecting the user's behavior, a relationship or an issue. For example, the tool 400 may ask the user to determine whether the user has an “all or nothing” attitude or is engaging in overgeneralizations or attempting to read someone else's mind (e.g., making assumptions about what another person believes or is thinking) According to some aspects, if a user indicates that he or she has fallen within a thinking trap, a prompt may be displayed providing information on how to escape or avoid the trap. Additionally or alternatively, predefined actions designed to help the user navigate out of and stay away from the trap may be suggested or automatically added by the system.

Without tool 400, a user might not fully appreciate and realize the issues caused by and underlying the user's current behavior, attitude and/or beliefs. With a concurrent display of the various situational information described herein, the tool may offer the user and/or a coach significant insight into the user's need to change. For example, tool 400 may reveal what the user specifically needs to do (e.g., actions) in order to create a change in his or her behavior or environment.

Training tool 400 may, in addition to providing thought provoking interactions, include a list of actions 429 that are to be taken in association with improving this relationship. As noted above, the actions may be identified and/or selected manually by a user or coach or automatically by a system or both. In the illustrated example, the user is assigned three actions in order to improve the relationship with the other individual. The actions may be defined by the user and added to a list of actions to be completed by the user. Notes may be added to each action (e.g., a progress made) using option 413 and a deadline for completion might also be displayed. A user may have the option to delete an action using option 415 or to mark an action completed using checkbox 417.

Header bar 419 of tool 400 provides general information regarding the relationship between the user and the individual. For example, bar 419 includes a goal progress indicator 421 specifying a number actions completed and number of actions defined. Additionally, an icon or image 423 may be displayed in a manner that reflects a quality or state of the relationship. For example, image 423 may be filled ¾ of the way to indicate that more work needs to be done. The user's relationship status may be modified manually by the user by selecting a relationship status from menu 425. Additionally, the user may choose to remove a relationship entirely using option 427.

The use of a cognitive analysis tool such as tool 400 facilitates scalability of the behavioral change system. That is, because the cognitive analysis tool guides the user in self-analysis and self-reflection, a real-life coach might not be needed or might not be needed as much. As such, the behavioral training system may be used train a multitude of users since the human capital requirements might not need to scale as significantly (or to the same degree as the number of users being trained). Furthermore, even when coaches are used, the role of a coach may be limited to guiding users in the use of the cognitive analysis tool and monitoring the users' progress. Accordingly, a coach may be more readily able to guide multiple trainees or users at one time.

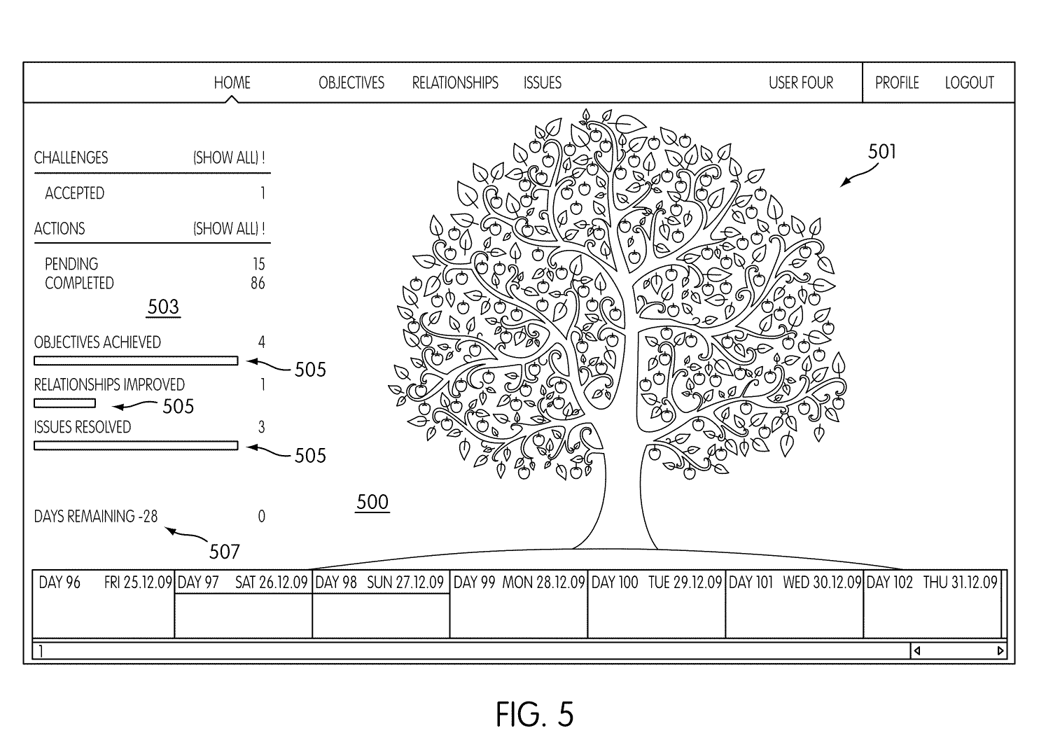

Progress toward behavioral change is often difficult to visualize. As a result, those seeking to affect change may become frustrated or disillusioned by a training or improvement process since the results are not always blatantly visible. To keep users motivated, encouraged and interested, a training system and tool may include various ways through which the user may track and view the progress he or she is making FIG. 5, for example, illustrates an interface 500 in which a user's progress is visually represented by an image such as tree 501. Interface 500 may further include a status dashboard 503 displaying information relating to challenges accepted, actions pending and completed, objectives achieved, relationships improved and issues resolved. The image of tree 501 may reflect the information displayed in dashboard 503. For example, a system may simulate growth of tree 501 upon completion of an objective, improvement of a relationship or resolution of an issue, or completion of an action corresponding thereto. Accordingly, the visual representation of the user's progress, i.e., tree 501, may offer confirmation to the user that the user has made progress in his or her training With confirmation, a user is more likely to feel motivated to take the next step and continue with the training program. Growth of tree 501 may be displayed in real-time. For example, upon a user marking an action or objective as completed, the growth of tree 501 may be simulated.

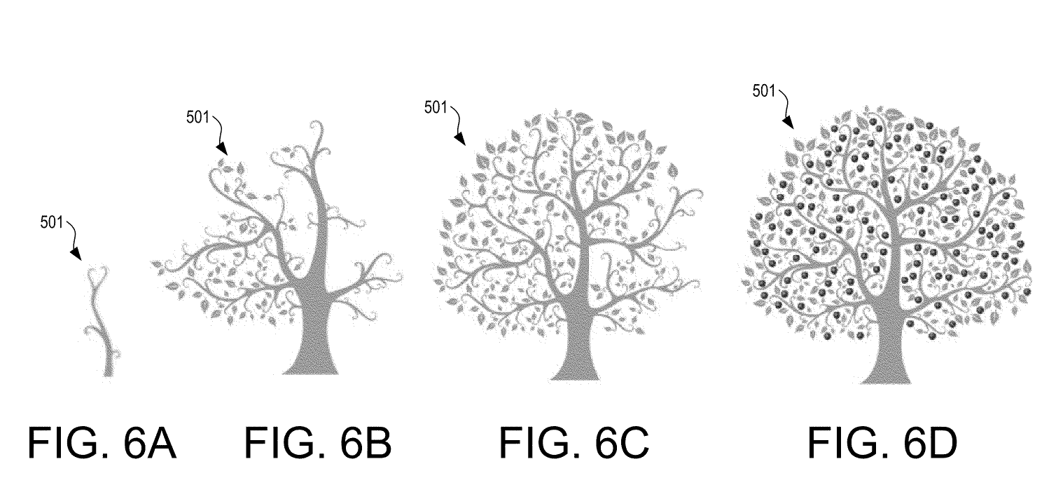

FIGS. 6A-6D illustrate an example growth progression of tree 501. In one or more arrangements, various aspects of the tree such as apples, other fruits, leaves, acorns, animals and the like may be displayed upon the user completing particular objectives or reaching certain milestones. For example, an apple may grow and appear on the tree for every 5 actions taken. In another example, an apple might only be awarded and be displayed on tree 501 when the user has completed a specific objective, improved a particular relationship and/or resolves a particular issue. In other examples, apples or other items may be provided as rewards on a random or semi-random basis. Providing such rewards on a random or semi-random basis may make progress tracking more exciting since the user might not know when the next reward will be received. In one or more arrangements, rewards may be taken away or tree 501 may deteriorate if the user is not making any or a predefined threshold level of progress. For example, the state of tree 501 may revert from the form of FIG. 6D to that of FIG. 6C if no action or other threshold amount of action has been taken in the past 2 weeks. This sort of regression may offer added motivation and incentive for a user to continue improving even though tree 501 may have reached a maximum state. In one or more arrangements, a training interface may allow a user to view an animated progression of tree 501 between two points in time. The user may thus visually determine the amount of behavioral change progress that was made during that time period. Additionally or alternatively, users may be provided with an option to view the state of tree 501 at different points in time. For example, the user may select a previous date to view the state of tree 501 at that time.

Various types of visual representation may be used to entertain the user and/or to pique the user's interest. For example, an obscured image may be displayed and as the user makes progress, pieces of the image are revealed. Once the user has completed all objectives, relationships and issues, the entire image would be revealed. Additionally or alternatively, real world rewards may be awarded to the user upon reaching predefined goals. For example, discounts to various products or services, products, vacation days and the like may be rewarded for completing a certain number of objectives or improving a specified number of relationships.

Progress through a training program may also result in the unlocking of various functions within the training tool. For example, once a user has improved at least 3 relationships, the system may unlock a relationship map functionality as described below. By locking the relationship map functionality prior to the user improving at least 3 relationships, the user may be forced to learn certain skills (e.g., self-motivation). If certain functions such as the relationship map function were enabled from day one, the user might only rely on the motivation provided by the relationship map without developing his or her own desire to improve. In other examples, some functionality may be locked prior to a user achieving a certain level of progress as a way to help the user learn how to use the training tool and interfaces. That is, if the user is presented with 10 different functionalities at once, the user may have difficulty learning all 10 to a satisfactory degree. Instead, presenting 3 or 4 at a time may allow the user to master those 3 or 4 tools or functions prior to training the user to learn the next 3 or 4 functions or tools.

Referring again to FIG. 5, dashboard 503 may convey a current state of a set of objectives, relationships or issues using progress bars 505. The length of progress bars 505 may represent the number of objectives, relationships or issues completed, improved or resolved, respectively. Further, a color of the progress bars may indicate how recently progress was made for that particular training category. For example, a progress bar may be displayed in a first color, with a first transparency and/or first pattern if a user made progress for that training category in the past week. A progress bar for a category in which the user has not made any progress in the past week may be displayed in a second color, with a second transparency and/or with a second pattern. Other and more or less time periods may be indicating a recency of progress. Additionally or alternatively, dashboard 503 may display countdown 507 to provide the user with a sense of urgency, thereby motivating the user to take further actions.

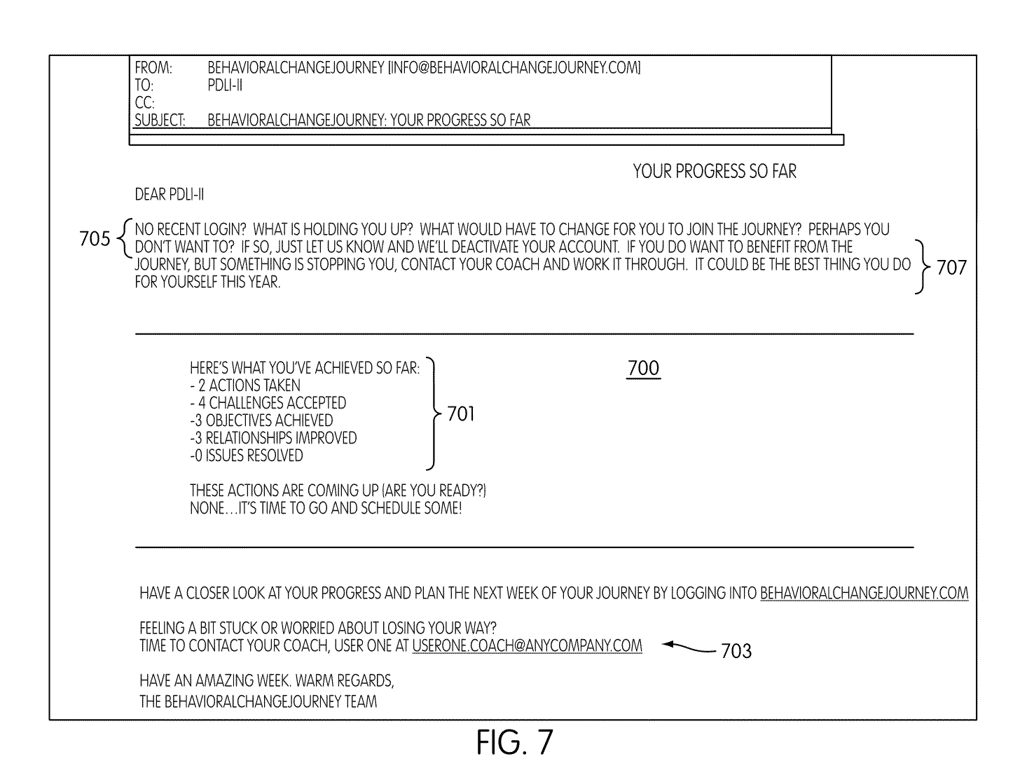

Another tracking tool includes progress messages that may be delivered to users on a periodic or aperiodic schedule. These progress messages may include various types information including a status update on each training category. FIG. 7 illustrates an example progress report message 700 in which a summary of the actions taken, challenges accepted, objectives achieved, relationships improved and issues resolved are displayed in a portion 701 of message 700. The message may also provide a link 703 to a visualization such as that of interface 500 (FIG. 5) that may offer more details of the user's progress. In one or more arrangements, message 700 may include a summary or analysis 705 of the user's progress or lack thereof. For example, analysis 705 may indicate that the user is already in week 5 of the training program but has not started training Analysis 705 may further indicate that at the current pace, the user will not achieve much progress. One or more motivational messages or suggestions 707 may also be provided to help encourage the user to continue or improve upon a current progress pace. The frequency with which a message 700 is delivered to users may be configured and/or defined by the trainee, a coach and/or a computing system. Messages may be provided as electronic mail, physical mail, text messages and the like.

In one or more arrangements, a behavioral training system may include one or more community features that allow multiple users to interact with one another in reaching a goal. For example, a user's progress may be tracked and posted to a social networking site such as FACEBOOK. By posting progress data, the user may receive feedback (e.g., encouragement or gifts) for the progress made thus far. The user may also receive advice and other types of information in response to the post. In another example, users may be provided with a chat forum in which users may discuss various goals, actions, relationships, thought processes, thinking traps and the like in real-time. The chat forum may be access through an option displayed in one or more training tools including the cognitive analysis tool and/or a relationship mapping tool. By using social features in the training system, the journey to behavioral change may be more social and interactive than in systems that simply provide strict individual-based training

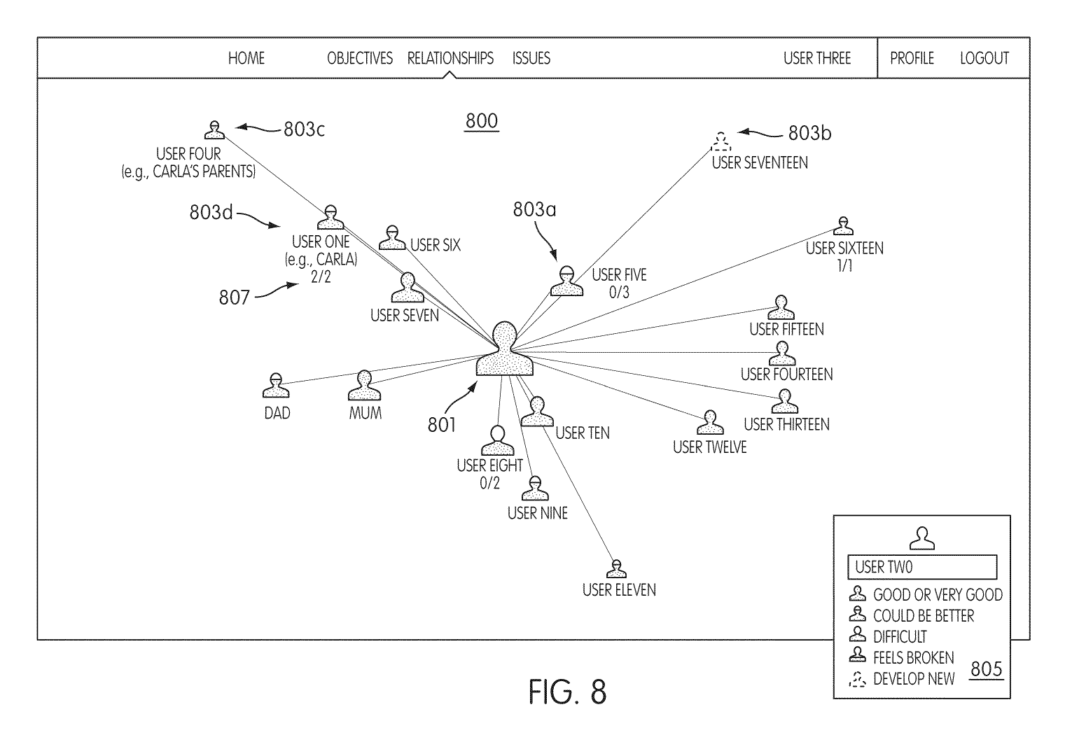

For relationship training, a system may provide a visualization tool that helps a user identify the status of a user's relationship with another individual. FIG. 8 illustrates an example relationship visualization interface 800 through which relationships may be represented in a visually easy to understand manner. In interface 800, a user is represented by icon 801 while other individuals are represented by icons 803. These other individuals correspond to people with whom the user currently has a relationship or would like to develop a relationship. For example, the individuals that are represented by icons having solid lines and/or are at least partially filled (e.g., icon 803a) may be existing relationships while individuals that are represented by icons having broken lines and/or that are not filled at all (e.g., icon 803b) may be potential new relationships. The relationships may be defined by the individual represented by icon 801 or by a coach or a combination of both. Alternatively or additionally, the relationships may be defined from another party or entity such as an organization to which the individual belongs.

The amount by which a particular icon, e.g., icon 803a, is filled may represent a status or level of the relationship between the user and the individual represented by the icon. A legend 805 provides an explanation of the various statuses and levels. For example, a quarter filled icon may represent a relationship that feels broken to the user while an icon that is ¾ filled may represent a relationship that feels stronger, but could be improved. Additionally, the quality of a relationship (e.g., how emotionally or physically close another individual is to the user) may be represented by the distance between an icon representing an individual (e.g., icon 803b) and icon 801 representing the user in interface 800. For example, Carla's parents (represented by icon 803c) may be acquaintances while Carla (represented by icon 803d) may be a friend. Accordingly, icon 803d may be located closer to icon 801 than icon 803c. The status of the relationship and the distance or quality of a relationship may be defined by the user or by a coach. The user may further add or delete relationships using interface 800. Each icon 803 is further associated with an action tracker 807. Action trackers 807 identify a number of pending actions assigned to the user for improving the particular relationship and a number of completed actions. Thus, a value of “ 0/3” may indicate that the user has completed none of the assigned actions for that particular relationship while a value of “⅓” indicates that the user has completed one of the three assigned actions. Other attributes of a relationship such as a type of relationship (e.g., friend, work, family) may be represented by a visual aspect on the relationship map. For example, a type of relationship may be represented by a color of the icon representing the corresponding individual (e.g., different colors may represent different types of relationships).

In one or more arrangements, the system may allow the user to toggle between different versions or states of the relationship map displayed in interface 800 to view changes in the relationships over time. For example, the state of the icons including location on the map (e.g., relative to the user), status and other information may be stored at predefined times or upon user command. Accordingly, the user may revisit the stored maps to compare relationships at different times and determine an amount of progress made (or a lack of progress made). In particular, one or more configurations may include storing an original state (e.g., when a relationship and individual was first defined) and redisplaying the original state at a later time for comparison purposes. Alternatively or additionally, the system may use all of the stored states to generate an animation between the various states in a chronological order. For instance, icon 803a may have been originally defined as being farther away from user icon 801 and not filled. To view a progression in that relationship, the system may animate a transition from original state of icon 803a as described above and the state of icon 803a displayed in interface 800. That is, icon 803a may be animated as moving close over time and filling up over time (e.g., to represent an improve status of the relationship). While the illustrated relationship map of interface 800 is presented in 2-D format, a 3-D version of the relationship map may also be generated.

By allowing the user to view multiple aspects and attributes of relationships simultaneously through a single map, the user may be offered a more comprehensive picture of the effects of his or her behavioral changes. That is, rather than viewing one attribute or one relationship at a time, the user may view the more dramatic and wide-reaching impacts his or her changes, actions and improvements are creating. This may also help the user better track his or her accomplishments and progress through improving various relationships to develop a particular soft skill and/or achieve behavioral change.

Since individuals being trained might not have requisite knowledge or expertise to determine what actions are necessary to resolve issues, improve relationships or complete objectives, a training tool may include the use of a coach. Coaching may be offered by other individuals including co-workers, bosses, friends, family and the like. Additionally, coaches may offer advice to and guide many users at one time. This allows the training tool to scale to large corporations and other organizations to affect cultural and environmental changes within the workplace. That is, a coach may modify the atmosphere of the work environment by training each of the users within that environment. Additionally, a coach may be able to determine, at a higher level, the best approach to improving the culture of the work environment and coordinate objectives and goals for each of the users of the environment.

To facilitate coaching, a training system may offer coaching tools and, in particular, tools that allow coaches to analyze data across multiple trainees (e.g., throughout a work department or a company). These tools may also be used by the users themselves so long as appropriate permissions and privileges are set. For example, a coach may wish to prevent others from viewing a user's training information and thus set a privacy control for that user. In another example, a user may wish to keep his or her information private, only allowing the coach to view and analyze his or her progress.

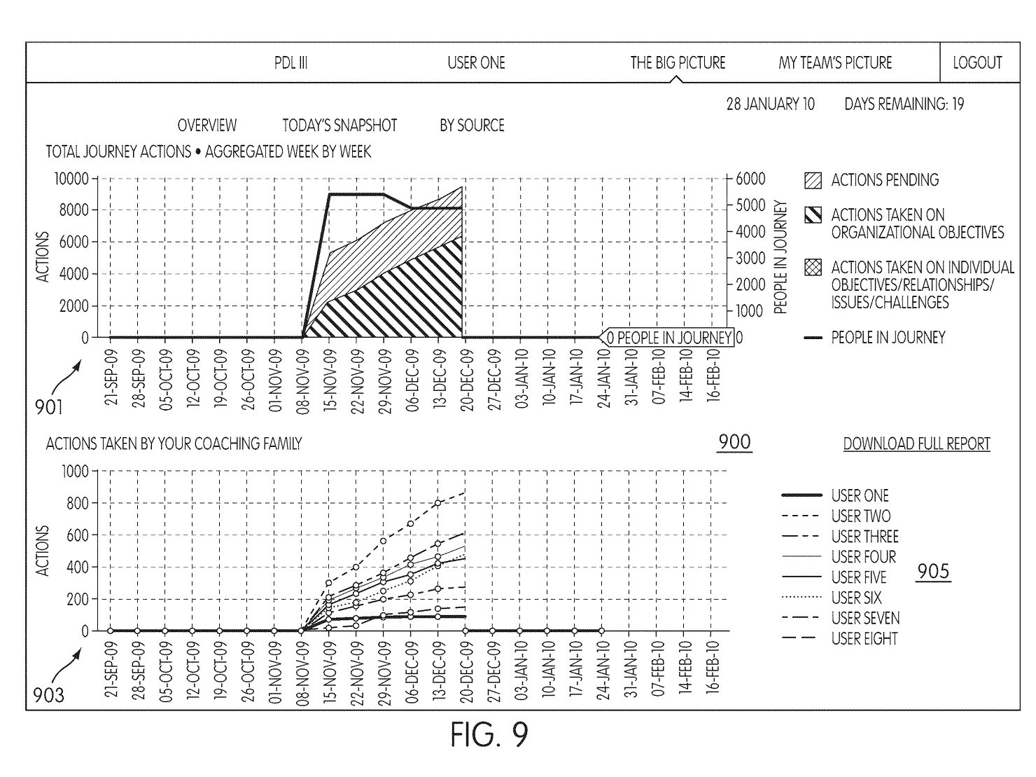

FIG. 9 illustrates an example analysis tool that provides information on actions taken over a period of time. Coaches may use the tool to determine an overall progress on an individual level as well as on an organization level. Interface 900 includes two graphs: graph 901 and graph 903. Graph 901 conveys a total number of actions taken in an organization and may be broken down by actions pending, actions for organizational objectives and actions for individual goals such as objectives, relationships, issues and challenges. Graph 901 may also include a line that represents a total number of participants in the training Graph 903, on the other hand, displays a total number of actions taken by a coaching family and is broken down by individual. Interface 900 displays a color-coded list of the individuals in portion 905. Using the information displayed in interface 900, a coach may determine a progress being made both on an individual level and on an organization level. The coach may also determine if individuals are concentrating more on organizational objectives or on individual goals. For example, if the coach determines that individuals are achieving more individual goals than organizational objectives, the coach may define and assign more organization objectives and decrease the number of individual goals to affect a more balanced improvement on both an individual level and an organization level. The coach may either do this directly, or by sending/assigning the individual or group of individuals a challenge to appear on their dashboard and timeline. The individual breakdown of actions taken as shown in graph 903 may also allow a coach to identify those individuals that might be hindering the training and improvement process. The coach may thus focus more on working with those individuals than others who may be achieving more success.

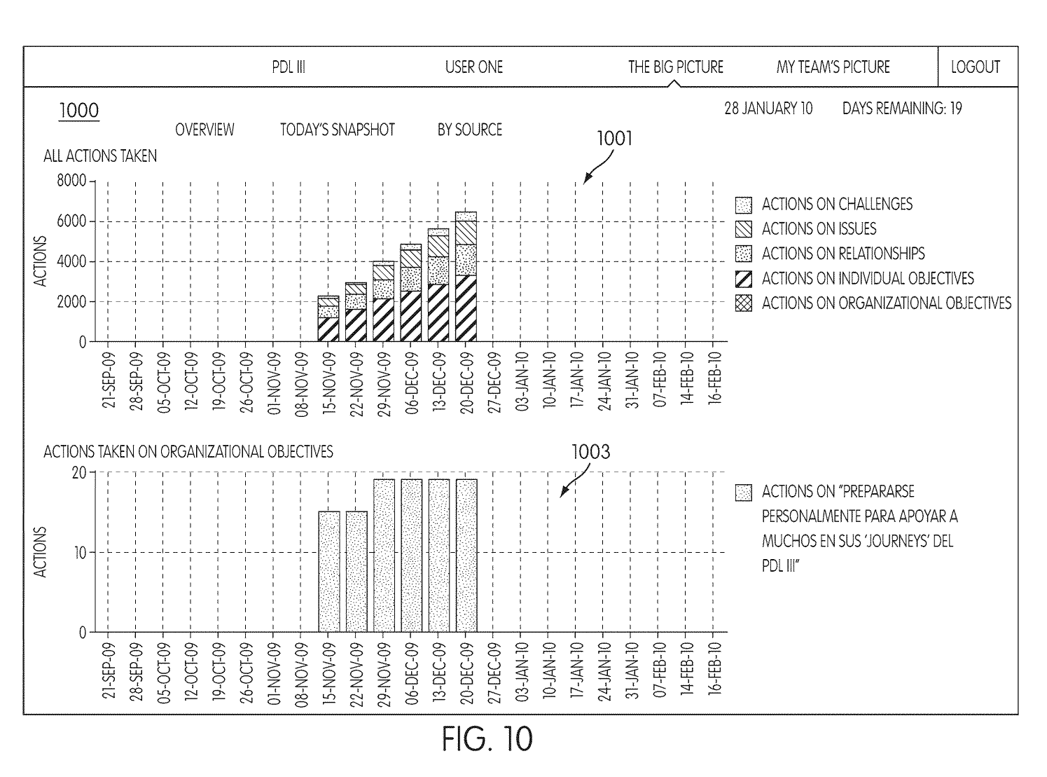

FIG. 10 illustrates another analysis interface 1000 in which a number of actions taken are graphed over time and broken down by a corresponding goal category. For example, in graph 1001, the total number of actions taken each week is broken down by the number of actions on challenges, the number of actions on issues, the number of actions on relationships, the number of actions on individual objectives and the number of actions on organizational objectives. Each of these categories may be color coded in graph 1001. Graph 1003, on the other hand, displays a number of organizational objectives taken each week and is broken down by organization objective. In the illustrated example, only one organization objective is selected for graphing and thus, graph 1003 only displays a single continuous bar for each week (rather than a bar with multiple delineations that represent different organization objectives).

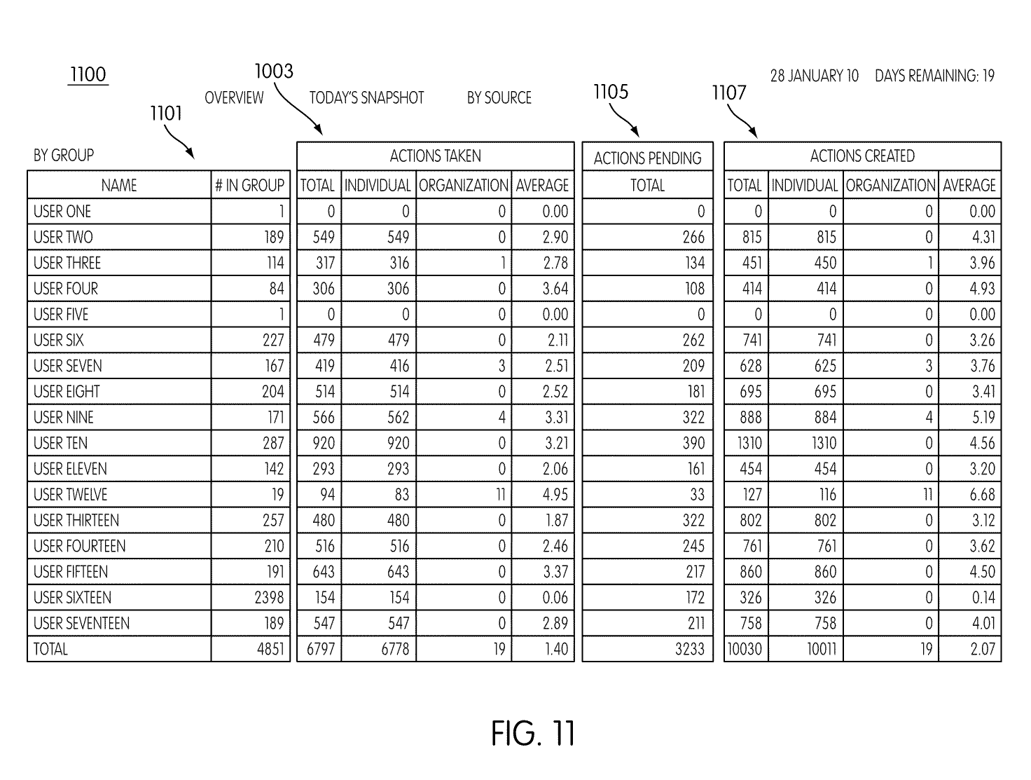

FIG. 11 illustrates another analysis interface 1100 displaying a list of individuals in a training group. Each individual's training statistics may be displayed as well. For example, an individual's position within a group (e.g., based on level of progress) may be displayed in column 1101 while actions taken statistics may be displayed in columns 1103. The actions taken statistics may include a total number of actions taken and an average number of actions taken per day or per week or other time period. Column 1105 may identify the number of pending (e.g., incomplete) actions and columns 1107 may specify the number of actions created by the individual. Again, these statistics and information may be used by a coach to identify strengths and weaknesses within groups and for each individual. The coach may then better tailor training programs and coaching for the individual.

One aspect of a training system and tool is scalability for large organizations (e.g., including hundreds or thousands of individuals). Generally, it may be difficult for a single user to coach each of hundreds or thousands of individuals within the organization. However, it is generally beneficial and desirable for those individuals with greater expertise and experience to provide that knowledge to all that are less experienced. Accordingly, in one or more arrangements, a training system may allow an organization to create and manage a hierarchical coaching tree that allows the use of multiple coaches so that a single coach does not need to track hundreds or thousands of users at one time. By using a hierarchical coaching tree, an organization may leverage the experiences and expertise of the most senior coaches while not requiring those senior coaches to train every individual in the organization

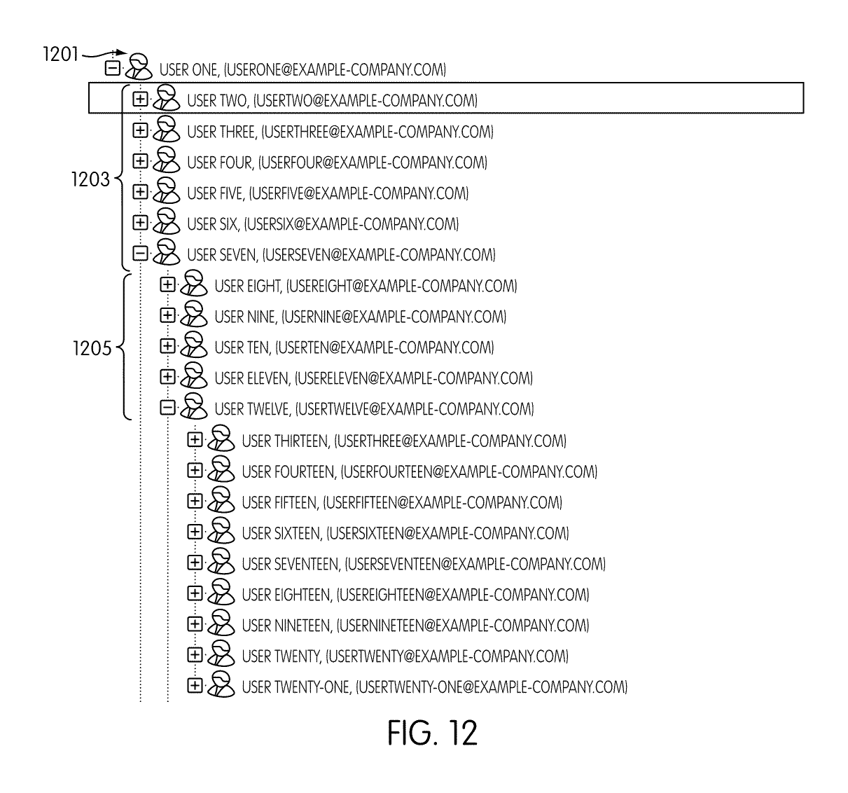

FIG. 12 illustrates an example hierarchical coaching tree in which a first coach 1201 coaches a first set of trainees 1203. One or more of trainees 1203 may further serve as coaches for a second set of trainees 1205 and so on. Trainees 1203 may have less experience or may be less skilled than coach 1201 while trainees 1205 may have less experience or may be less skilled than their respective coaches of trainees 1203. This insures that a trainee is being coached by a coach with more experience and progress than the trainee. However, information provided by a first coach, such as coach 1201, may be passed down not only to his or her immediate trainees (e.g., trainees 1203), but also to indirect trainees such as trainees 1205 through their respective coaches. This allows trainees 1205, for example, to benefit from the advice and guidance of coach 1201 without requiring coach 1201 to specifically track trainees 1205 on an individual basis. Clearly, using such a hierarchical coaching tree offers tremendous scalability since a limit on a number of trainees for any one coach may be defined and enforced through the coaching tree structure.

In one or more arrangements, a coach such as coach 1201 may view statistics and information (such as those provided in FIGS. 9-11) of all trainees within his or her coaching family (e.g., all children in his or her tree) or for only immediate trainees (e.g., only children and not grandchildren or lower). The coach may configure the view as he or she desires or prefers.

Another category of behavior change tasks may include challenges. Challenges may represent tasks that require collaboration with at least one other individual to complete and may reflect objectives or tasks that are broader in scope than actions. For example, a challenge may be to speak to 3 clients that the user has not spoken to for the last quarter. The user's 3 actions to address this challenge may include 1) calling John tonight, 2) sending email tomorrow to Vicky asking her for a meeting and 3) making sure to talk to Steven at company drinks on Thursday. Invitations to participate in challenges may be triggered by a user completing a particular action or objective, improving one or more relationships (or a certain number of relationships), or resolving one or more issues (or number of issues). For example, if the system determines that the user has focused a majority of his or her actions on improving 3 or fewer relationships, the system may offer a challenge to improve a relationship with someone that is not as familiar with the user.

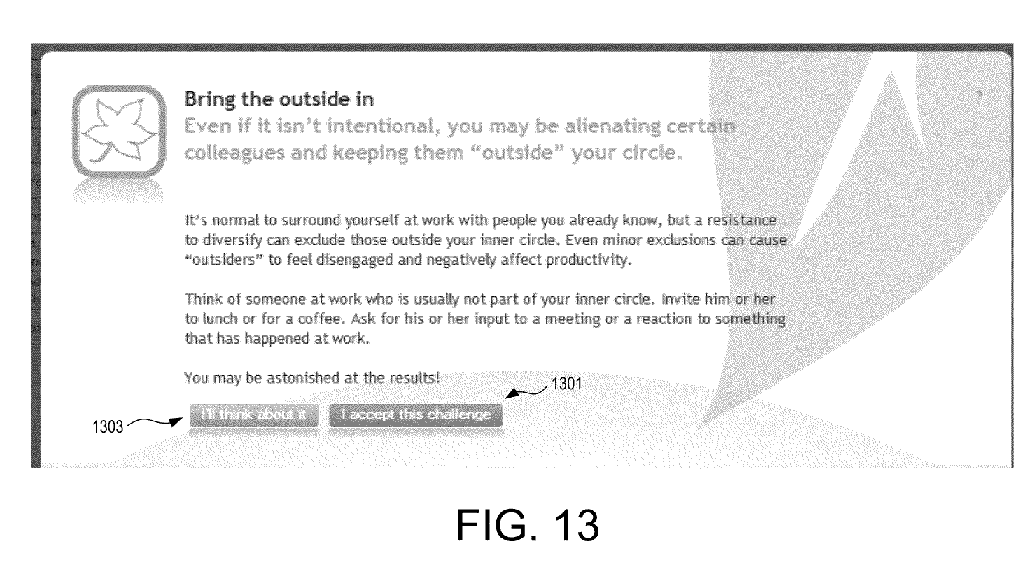

FIG. 13 illustrates an example challenge interface in which the user is challenged to invite a colleague that is “outside” of the user's circle to coffee or lunch and discuss a particular topic. The user may accept the challenge using option 1301 or defer a decision using option 1303. If the user defers the decision, the system may schedule a reminder or another invitation at another time (e.g., a week, two days, 2 weeks, a month, etc.). If, on the other hand, the user accepts the challenge, the user may be given the option of creating and/or scheduling actions associated with the challenge. Challenges may be identified differently than non-challenges (e.g., actions for objectives, relationships or issues) on a calendar.

Other collaborative aspects of behavior change training may include common objectives between trainees. By setting common objectives, individuals may not feel they are traveling along the journey to change by themselves. Instead, the individuals may discuss the objectives with others and approaches to completing those objectives. They may also discuss failures or difficulties with one another, which may lead to breakthroughs in thinking and development of solutions for navigating through the failures and difficulties.

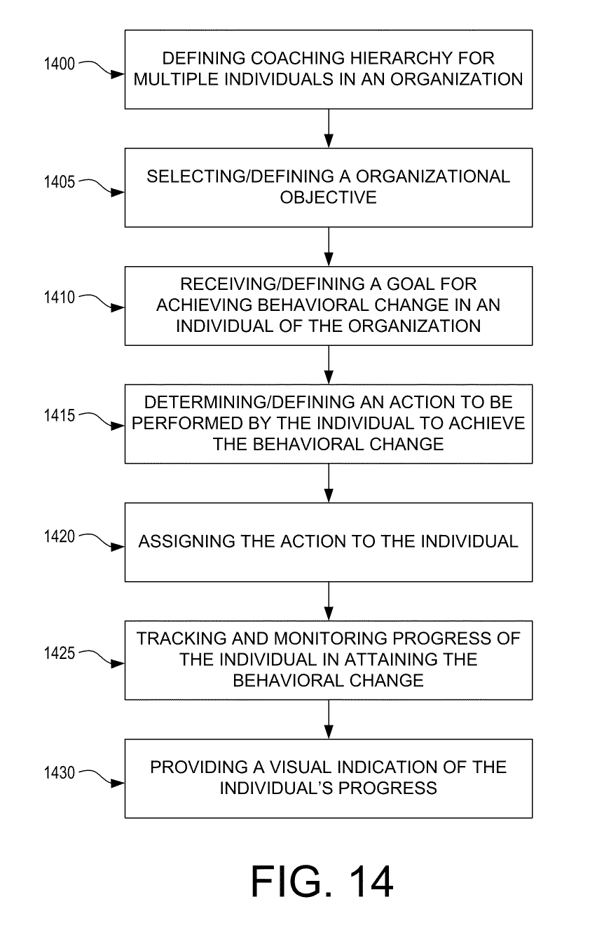

FIG. 14 illustrates a method by which an organizational objective may be defined and achieved. The organization for which the objective is defined may include multiple users and thus require that the training tool and program is scalable to the size of the organization. Accordingly, in step 1400, a coaching hierarchy may be defined to manage coaching/trainee relationships between the multiple individuals of the organization. The coaching hierarchy may be created by creating a coaching tree (e.g., tree as illustrated in FIG. 12). In step 1405, an organizational objective may be selected or defined. For example, the objective may be selected by a member of the organization (e.g., a CEO, a manager, etc.). In step 1410, a goal may be defined for an individual in the organization. For example, a coach may define or select a goal such as completing an objective, improving a relationship and/or resolving an issue for a trainee assigned to the coach in the defined coaching hierarchy. The defined goal for the individual may correspond to the organizational objective. That is, by the individual completing the goal, progress may be achieved toward the organizational objective. In one example, the organizational objective may include improving efficiency within all departments of the company. Accordingly, an individual goal may be defined as improving relationships with all other individuals in the individual's department.

In step 1415, one or more actions may be defined to help the individual achieve progress toward the individual goal. The actions may be defined by the coach or by the individual for whom the goal is defined. In step 1420, the one or more actions may subsequently be assigned to the individual. The actions may be assigned to the user by the user himself or herself or by other individuals (e.g., a coach) or automatically by a system. In step 1425, the training system may track the progress of the individual in completing the actions. For example, the system may determine a number of actions completed and a number of actions still pending. In step 1430, the training system may further track the progress of the individual in reaching the goal. In one or more arrangements, reaching or achieving a goal may include multiple sub-goals that may include completing objectives, improving relationships and resolving issues. Accordingly, a user may be required to improve 2 relationships, complete 3 objectives and resolve 1 issue in order to achieve the defined goal (e.g., a behavioral change). In step 1430, a visual indication may provide a visual indication of the individuals progress. In one example, the visual indication may include a progress report and may be provided to a coach and/or the individual. Further, the progress report may aggregate progress information for a plurality of individuals (e.g., all individuals in an organization, all trainees of a particular coach).

The process of steps 1410-1430 may be performed for all or multiple individuals of the organization to achieve the defined organizational objective. In one arrangement, a root individual of the coaching tree may assign goals or objectives to the individual's immediate trainees such that those goals will require the other trainees in the lower levels of the coaching tree to affect the behavioral changes necessary to achieve the organizational objective.

The methods and features recited herein may further be implemented through any number of computer readable media that are able to store computer readable instructions. Examples of computer readable media that may be used include RAM, ROM, EEPROM, flash memory or other memory technology, CD-ROM, DVD, or other optical disc storage, magnetic cassettes, magnetic tape, magnetic storage and the like.

While illustrative systems and methods described herein embodying various aspects are shown, it will be understood by those skilled in the art that the invention is not limited to these embodiments. Modifications may be made by those skilled in the art, particularly in light of the foregoing teachings. For example, each of the elements of the aforementioned embodiments may be utilized alone or in combination or sub-combination with the elements in the other embodiments. It will also be appreciated and understood that modifications may be made without departing from the true spirit and scope of the present invention. The description is thus to be regarded as illustrative instead of restrictive on the present invention.

What is claimed is:

1. A method comprising:
defining, in a computing system, a coaching hierarchy for an organization comprising a plurality of individuals, wherein a first individual is assigned a coaching role for a second individual and the second individual is assigned a coaching role for a third individual;
defining, in the computing system, an organizational objective configured to modify at least one behavioral aspect of organization;
receiving, by the computing system, a selection of a first goal for attaining behavioral change of the third individual, wherein the behavioral change corresponds to a non-physical attribute of the third individual and is configured to achieve progression toward completion of the organizational objective;
defining, by the computing system, an action for the third individual, wherein completion of the action is configured to progress the third individual toward achieving the behavioral change; and
providing, by the computing system, a visual indication of a completion status of the first goal.

2. The method of claim 1, further comprising, prior to defining the action for the third individual:
displaying a thought process analysis interface including a plurality of self-evaluation questions; and
receiving responses to the plurality of self-evaluation questions from the third individual.

3. The method of claim 1, further comprising receiving a selection of a second goal for attaining behavioral change of a fourth individual, wherein the behavioral change of the fourth individual corresponds to a non-physical attribute of the fourth individual and is configured to achieve progression toward completion of the organizational objective.

4. The method of claim 3, wherein the first and second goals are selected by the second individual.

5. The method of claim 4, wherein the visual indication includes a completion status of all goals assigned to the third and fourth individuals and wherein the visual indication is provided to the second individual.

6. The method of claim 1, further comprising:
receiving coaching feedback relating to the organizational goal from the first individual; and
distributing the coaching feedback to the second and third individuals.

7. The method of claim 1, wherein the action is defined by the third individual.

8. The method of claim 1, further comprising defining a schedule for completing the action by the third individual.

9. One or more non-transitory computer readable media storing computer readable instructions that, when executed, cause an apparatus to:
generate a first graphical user interface comprising an object in a first display state representing a first amount of progress an individual has made toward achieving a behavioral change, wherein the behavioral change corresponds to a non-physical attribute of the individual; and
generate a second graphical user interface upon the user reaching a second amount of progress toward achieving the behavioral change, the second amount of progress being greater than the first amount of progress, wherein the second interface comprises the object in a second display state representing the second amount of progress, and wherein the first state is different from the second display state.

10. The one or more non-transitory computer readable media of claim 9, wherein the computer readable instructions, when executed, further cause the apparatus to:
generate the first interface after generating the second interface and upon determining that the user has not achieved a threshold amount of progress over a specified period of time.

11. The one or more non-transitory computer readable media of claim 9, wherein the computer readable instructions, when executed, further cause the apparatus to:
receive an instruction to review progress made by the individual toward achieving the behavioral change; and
generating an animation of the object progressing from the first display state to the second display state.

12. The one or more non-transitory computer readable media of claim 9, wherein the progress towards achieving the behavioral change is measured by a number of actions performed by the individual.

13. The one or more non-transitory computer readable media of claim 9, wherein the first user interface further comprises a progress tracking toolbar displaying a number of actions completed and a number of actions to be completed.

14. The one or more non-transitory computer readable media of claim 9, wherein the number of actions completed is conveyed in the first user interface using a progress bar and wherein a color of at least a portion of the progress bar is determined based on a recency of a last action completed.

15. The one or more non-transitory computer readable media of claim 14, wherein the at least a portion of the progress bar is displayed in a first color when the last action was completed at most a predefined amount of time prior to a current time and a second color when the last action was completed before the predefined amount of time prior to the current time.

16. The one or more non-transitory computer readable media of claim 14, wherein the computer readable instructions, when executed, further cause the apparatus to:
provide an option allowing a user to select a previous time; and
generate an interface comprising the object in a display state corresponding to the previous time.

17. One or more non-transitory computer readable media storing computer readable instructions that, when executed, cause an apparatus to:
generate a first graphical user interface configured to represent a quality and status of a relationship between a first individual and at least one second individual at a first time, wherein the first graphical user interface includes:
a first image representing the first individual; and
a second image representing the second individual, wherein the placement of the second image relative to the first image corresponds to a level of acquaintance between the first and second individuals and an appearance of the second image represents a quality of the relationship.

18. The one or more non-transitory computer readable media of claim 17, wherein the second image is displayed as being filled to a first point within the image when the quality of the relationship is at a first level and the second image is displayed as being filled to a second point within the image different from the first point when the quality of the relationship is at a second level different from the first level.

19. The one or more non-transitory computer readable media of claim 17, wherein the first and second levels are defined by the first individual.

20. The one or more non-transitory computer readable media of claim 17, wherein the computer readable instructions, when executed, further cause the apparatus to:
generate an animation displaying a progression between the first graphical user interface and a second graphical user interface, wherein the second graphical user interface is configured to represent a quality and status of a relationship between a first individual and at least one second individual at a second time different from the first time.

21. A method comprising:
defining, in the computing system, an objective configured to modify at least one non-physical behavioral attribute of a first individual;
generating, by the computing system, a cognitive analysis tool configured to identify one or more misalignments in a thought process of the first individual in relation to the defined objective;
defining, by the computing system, one or more actions to be completed by the first individual, wherein completion of the one or more actions is configured to correct the one or more misalignments in the thought process of the first individual;
providing, by the computing system, a visual indication of a completion status of the objective, wherein the visual indication includes:
an object representing an amount of progress the first individual has made toward completing the objective, wherein a physical display attribute of the object is configured to change when the amount of progress changes; and
providing, by the computing system, a relationship visualization tool when the objective includes improvement of a relationship between the first individual and a second individual, wherein the relationship visualization tool includes an interface having:
a first image representing the first individual; and
a second image representing the second individual, wherein the placement of the second image relative to the first image corresponds to a level of acquaintance between the first and second individuals and an appearance of the second image represents a quality of the relationship.
